(19) United States
(12) Patent Application Publication
(10) Pub. No.: US 2018/0089688 A1
(43) Pub. Date: Mar. 29, 2018

(54) SYSTEM AND METHODS FOR AUTHENTICATING A USER USING BIOMETRIC DATA

(71) Applicant: MasterCard International Incorporated, Purchase, NY (US)

(72) Inventor: Manoneet Kohli, O'Fallon, MO (US)

(21) Appl. No.: 15/277,307

(22) Filed: Sep. 27, 2016

(51) Int. Cl. G06Q 20/40; G06F 17/30; G06Q 20/10; H04L 29/06

(52) U.S. Cl. CPC G06Q 20/40145; G06Q 20/409; H04L 63/0861; G06F 17/30867; G06Q 20/102; G06Q 20/4016

(57) ABSTRACT

A computer-based method for authenticating a user using biometric data is provided. The method is implemented using a biometric validation server in communication with a memory. The method includes storing, at the biometric validation server, a plurality of biometric identifiers, and receiving, from a requestor, an authentication request message for a payment transaction originating from an originating merchant for a cardholder. The authentication request includes a biometric identifier provided by the cardholder. The method also includes searching, at the biometric validation server, the plurality of biometric identifiers for a match to the received biometric identifier, determining whether to approve or deny the payment card transaction based, at least in part on, on whether or not a match is found, and transmitting the determination.

### BACKGROUND OF THE DISCLOSURE

The field of the disclosure relates generally to authenticating a user using biometric data, and more specifically to methods and systems for enhancing fraud detection by authenticating a payment card transaction of a user using biometric data to determine the user's transaction history.

In some cases, a cardholder may have multiple payment cards issued to the cardholder. These cards may be from different issuing banks or even from different payment networks. If the cardholder commits fraud on one of the cards, it may be difficult for the issuing banks associated with the other cards to know about the cardholder's fraudulent behavior. Thus, the cardholder can switch to a different payment card once their activities are discovered on the first card, and continue performing fraudulent transactions. This may occur where the cardholder has multiple payment cards that are simultaneously active for the cardholder. There exists a need to connect the transaction history of a cardholder across multiple payment card schemes to enhance fraud detection systems.

### BRIEF DESCRIPTION OF THE DISCLOSURE

In one aspect, a computer-based method for authenticating a user using biometric data is provided. The method is implemented using a biometric validation server in communication with a memory. The method includes storing, at the biometric validation server, a plurality of biometric identifiers and receiving, from a requestor, an authentication request message for a payment transaction originating from an originating merchant for a cardholder. The authentication request includes a biometric identifier provided by the cardholder. The method also includes searching, at the biometric validation server, the plurality of biometric identifiers for a match to the received biometric identifier, determining whether to approve or deny the payment card transaction based, at least in part on, on whether or not a match is found, and transmitting the determination.

In another aspect, a biometric verification computer device used for authenticating a user using biometric data is provided. The biometric verification device includes a processor communicatively coupled to a memory device. The processor is programmed to store a plurality of biometric identifiers and receive, from a requestor, an authentication request message for a payment transaction originating from an originating merchant for a cardholder. The authentication request includes a biometric identifier provided by the cardholder. The processor is also programmed to search the plurality of biometric identifiers for a match to the received biometric identifier, and transmit a response.

At least one non-transitory computer-readable storage media having computer-executable instructions embodied thereon is provided. When executed by a biometric verification computer device having at least one processor coupled to at least one memory device, the computer-executable instructions cause the processor to store a plurality of biometric identifiers and receive, from a requestor, an authentication request message for a payment transaction originating from an originating merchant for a cardholder. The authentication request includes a biometric identifier provided by the cardholder. The computer-executable instructions also cause the processor to search the plurality of biometric identifiers for a match to the received biometric identifier, and transmit a response.

### BRIEF DESCRIPTION OF THE DRAWINGS

FIGS. 1-6 show example embodiments of the methods and systems described herein.

FIG. 1 is a schematic diagram illustrating an example multi-party payment processing system for processing payment-by-card transactions.

FIG. 2 is a simplified block diagram of an example system used for authenticating a user using biometric data.

FIG. 3 illustrates an example configuration of a client system shown in FIG. 2, in accordance with one embodiment of the present disclosure.

FIG. 4 illustrates an example configuration of a server system shown in FIG. 2, in accordance with one embodiment of the present disclosure.

FIG. 5 is a flow chart of a process for authenticating a user using biometric data using the system shown in FIG. 2.

FIG. 6 is a diagram of components of one or more example computing devices that may be used in the system shown in FIG. 2.

### DETAILED DESCRIPTION OF THE DISCLOSURE

The following detailed description illustrates embodiments of the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure. These system and methods are configured to enhance payment transaction authentication using biometric data.

One risk-mitigating step against fraudulent cardholder transactions is cardholder authentication. For example, some payment networks engage an authentication service that performs an authentication of a suspect consumer prior to authorization of the transaction, particularly in the online purchasing area. The authentication service determines if the source of the transaction is the authorized user of the payment card. During such authentication, the suspect consumer (i.e., the person attempting to perform the payment card transaction with the merchant) may be presented with an authentication challenge, sometimes called a “step-up challenge.” This step-up challenge generally requires the suspect consumer to provide a password or a passcode from a second factor device before the transaction will be processed. In other embodiments, this step-up challenge requests biometric data from the suspect consumer, such as, but not limited to, a photo of their face/head, a fingerprint, and a retinal photo. By obtaining this additional factor from the suspect consumer, the likelihood of the suspect consumer being a fraudulent consumer is reduced.

As described herein, in one example, a cardholder may register for an authentication service through a bank which issued a payment card to the cardholder. During the registration process, the cardholder provides the issuing bank with authentication data, such as sample biometric data and/or other types of authentication data. For example, the sample biometric data may include a photo of the cardholder's face/head, a fingerprint, a retinal picture, and the like. Accordingly, the cardholder's sample biometric data is stored along with other payment account information, such as billing address that can be used to authenticate the cardholder.

Subsequently, the cardholder attempts to make a purchase through an online merchant. During checkout, the cardholder is asked to input their payment card or account information. Accordingly, the cardholder enters payment account information for the account associated with the authentication service. The online merchant forwards initial transaction information to a host computing device, which in the example embodiment is a payment processor for transaction processing. In response, the host computing device determines that the payment account is enrolled in the authentication service. For example, the host computing device may identify the account identifier within the transaction information and perform a lookup in a memory of the host computing device to determine if the payment account is enrolled in the authentication service. Based on cardholder information acquired during the enrollment process, the host computing device issues a step-up challenge requesting biometric data from the suspect cardholder. In the example embodiment, the suspect cardholder provides the requested authentication data through a personal computing device. For example, the suspect cardholder may provide biometric data (e.g., take a picture of their face, fingerprint, iris scan, etc.) using a camera of a smart phone, a smart watch, or some other personal computing device. The personal computing device transmits the captured biometric authentication data (e.g., the image) to the host computer. When the suspect cardholder transmits the biometric data, the host computer compares the biometric data from the suspect cardholder with the stored biometric data associated with the cardholder's account. If the two match, then the cardholder is authenticated. In some embodiments, if a difference between the captured authentication data and the sample authentication data is within a predefined threshold, the cardholder may be authenticated.

In the example embodiment, a biometric verification computer device (also known as a biometric verification server) includes a processor in communication with a memory. The biometric verification computer device is in communication with a payment processing network. In some embodiments, the biometric verification computer device may be a part of the payment processing network, for example the network interchange, or the biometric verification computer device may be separate from the payment processing network and merely in communication with the payment processing network. The payment processing network includes a point of sale, a merchant, a merchant bank, an interchange network, and an issuing bank (also known as an issuer processor). The biometric verification computer device is configured to assist the merchant in determining whether to approve or deny the candidate online payment transaction.

In the example embodiment, the biometric verification computer device stores a plurality of biometric identifiers in a database. The biometric identifiers are associated with payment card accounts. In the example embodiment, the payment card accounts are associated with one or more issuer processors. In some embodiments, each of the plurality of biometric identifiers are associated with cardholders who have been put on a blacklist, where the cardholder committed fraudulent behavior on the associated payment card account. In other embodiments, the plurality of biometric identifiers are stored with transaction history information for the payment account associated with the biometric identifier. In the example embodiment, at least one of a merchant bank, an interchange network, and an issuer bank added the biometric identifier and the associated transaction history to the database. In the example embodiment, the cardholder, associated with each biometric identifier of the plurality of biometric identifiers, provided the biometric identifier as a part of a biometric authentication service for the associated payment card.

In the example embodiment, the cardholder is enrolled in a biometric authentication service that uses the cardholder's biometric information to confirm the identity of the cardholder. In the example embodiment, as a step of initiating a payment transaction, the cardholder provides one or more biometric identifiers, such as, but not limited to, a fingerprint, an image, a retinal scan, and a voice print through a client system. At least one of the merchant, the merchant bank, the interchange network, and the issuer processor compares the provided biometric identifier to a stored sample biometric identifier that was provided previously by the cardholder, such as when the cardholder signed up for the biometric authentication service. If the stored sample and the provided biometric identifier match, then the identity of the cardholder is confirmed as being the cardholder associated with the payment card being used in the payment transaction.

In the example embodiment, the biometric verification computer device receives an authentication request message from a requestor. The authentication request message is for a payment transaction originating from an origination merchant and initiated by a cardholder. The authentication request message includes the biometric identifier used to confirm the identity of the cardholder. The biometric verification computer device searches the plurality of biometric identifiers for a match to the received biometric identifier. In the example embodiment, the biometric verification computer device compares the received biometric identifier to the stored plurality of biometric identifiers to find a match. The technique for comparison used varies based on the type of biometric identifier. In the example embodiment, the plurality of biometric identifiers is indexed based on the identifier and not by other identifying information.

In the example embodiment, the biometric verification computer device determines whether to approve or deny the payment transaction based, at least in part, on whether or not a match is found. In some embodiments, each of the plurality of biometric identifiers is associated with a cardholder that has performed fraudulent transactions on a payment card and have been blacklisted by at least one of a merchant bank, an interchange network, or an issuer bank. Since this blacklisting may occur on different interchange networks or different issuer banks, the interchange network and issuer bank associated with the present payment transaction may not have access to the blacklist and not be aware that an individual is blacklisted elsewhere. This may be the case where cardholder has multiple cards associated with multiple interchange networks and issuer processors. The cardholder may perform fraudulent transactions on one payment card, causing that cardholder to become blacklisted by at least one of the interchange network and the issuer bank associated with that payment card. However, the cardholder can then use his or her other payment cards without being affected by the blacklist. By comparing the biometric identifier from the cardholder to the plurality of biometric identifiers from blacklisted cardholders, the biometric verification computer device may determine if the cardholder has been blacklisted. If there is a match, the biometric verification computer device determines to deny the payment transaction. If there is not a match, the biometric verification computer device determines to approve the payment transaction. The biometric verification computer device transmits the determination to the requestor in an authentication response message.

In some embodiments, where the plurality of biometric identifiers are associated with transaction histories, the biometric verification computer device calculates a fraud score based on the transaction history associated with the match. In some further embodiments, the authentication request message includes one or more pieces of authentication data that the biometric verification computer device uses to calculate the fraud score. If the fraud score exceeds a predetermined threshold, the biometric verification computer device determines to deny the payment transaction. Otherwise, the biometric verification computer device determines to approve the payment transaction.

In some embodiments, an applicant may initiate an online credit request application with an issuer bank. The credit request application may be for a payment card, a loan, a line of credit, or any other credit request. In these embodiments, the applicant uses a client system, such as a smart phone, to initiate the online credit request application. As a part of the online credit request application, the applicant may sign the credit request application with a biometric signature, such as through a biometric authentication service. For example, the applicant may transmit one or more biometric identifiers as a part of the application process. In these embodiments, a computer system associated with the issuer bank transmits a query to the biometric verification computer device with the one or more biometric identifiers to verify the identity of potential cardholder. Based on the information returned by the biometric verification computer system, the issuer bank determines whether or not to approve the credit request application. In some further embodiments, the applicant may be at a branch of the issuer bank. The issuer bank may collect the potential cardholder's biometric information in person to transmit to the biometric verification computer device for authentication.

The methods and system described herein may be implemented using computer programming or engineering techniques including computer software, firmware, hardware, or any combination or subset. As disclosed above, at least one technical problem with prior systems is that there is a need for enhanced payment transaction authentication. The system and methods described herein address that technical problem. The technical effect of the systems and processes described herein is achieved by performing at least one of the following steps: (a) storing, at the biometric validation server, a plurality of biometric identifiers and a plurality of transaction histories associated with the plurality of biometric identifiers, wherein the plurality of transaction histories are associated with a cardholder and a corresponding payment card, wherein the plurality of biometric identifiers is searchable based on the biometric identifier, wherein the plurality of biometric identifiers are each associated with a blacklisted cardholder, and wherein the biometric identifier is one of a fingerprint, a photograph, and a retinal scan; (b) receiving, from a requestor, an authentication request message for a payment transaction originating from an originating merchant for a cardholder, wherein the authentication request message includes a biometric identifier provided by the cardholder, wherein the requestor is one of a merchant, an acquiring bank, and a payment network, and the cardholder is associated with a plurality of payment cards including a first payment card and a second payment card; (c) searching, at the biometric validation server, the plurality of biometric identifiers for a match to the received biometric identifier; (d) determining, at the biometric validation server, whether to approve or deny the payment card transaction based, at least in part on, on whether or not a match is found; (e) determining to deny the payment card transaction if a match is found; and (f) transmitting, by the biometric validation server, the determination to the requestor. The resulting technical effect is that a more accurate authentication system that provides a method of using transaction history from multiple payment cards associated with the same user to authenticate said user.

In some further embodiments, the technical effect of the systems and processes described herein is achieved by performing at least one of the following steps: (a) if a match is found, retrieving the stored transaction history associated with the matching biometric identifier; (b) calculating a fraud score based on the stored transaction history and the authentication information, wherein the authentication request message further includes authentication information; and (c) determining whether to approve or deny the transaction based on the fraud score.

In some further embodiments, the technical effect of the systems and processes described herein is achieved by performing at least one of the following steps: (a) receiving a biometric identifier for the cardholder based on the transaction history of the cardholder, wherein the transaction history is associated with a first payment card associated a first issuer and issued to the cardholder; (b) storing the biometric identifier; and (c) receiving the authentication request message including a biometric identifier for the cardholder, wherein the authentication request message is associated with a payment transaction associated with a second payment card associated with a second issuer associated with the cardholder.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transactions card can be used as a method of payment for performing a transaction.

In one embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer-readable medium and utilizes a Structured Query Language (SQL) with a client user interface front-end for administration and a web interface for standard user input and reports. In another embodiment, the system is web enabled and is run on a business entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the system and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

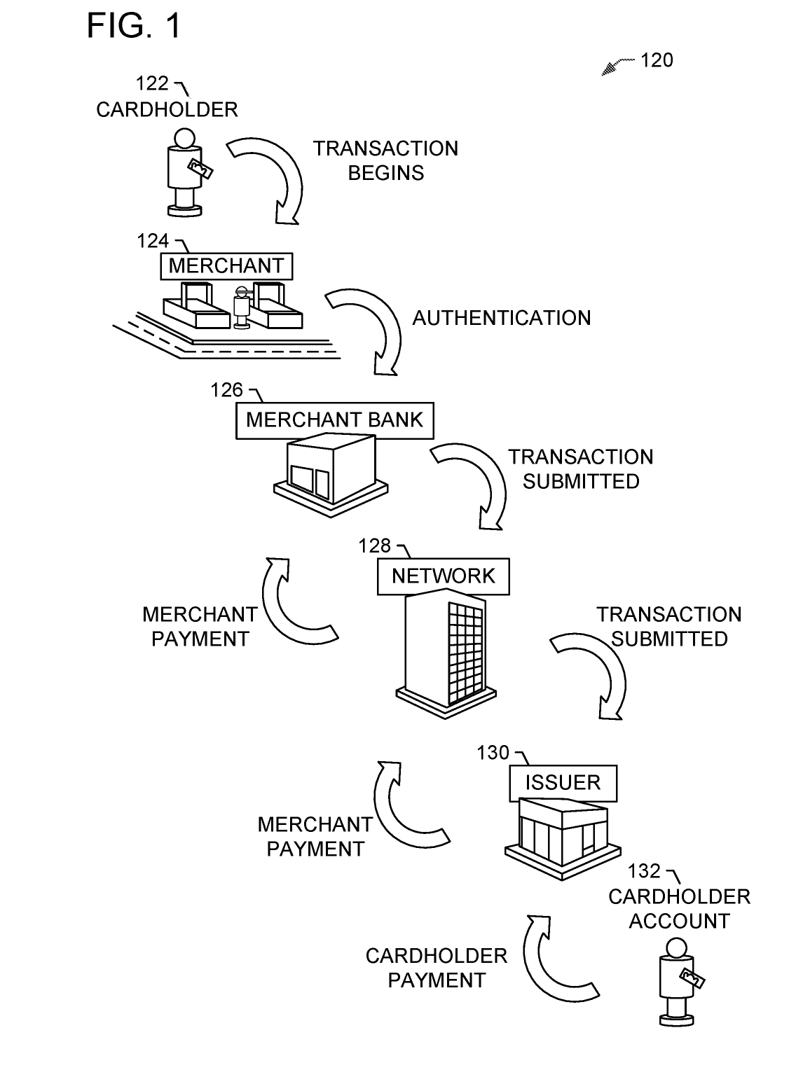

FIG. 1 is a schematic diagram illustrating an example multi-party payment processing system 120 for processing payment-by-card transactions between merchants 124 and cardholders 122. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are registered with MasterCard International Incorporated®. (MasterCard is a registered trademark of MasterCard International Incorporated located in Purchase, N.Y.).

In a typical transaction card system, a financial institution called the “issuer” issues a transaction card or electronic payments account identifier, such as a credit card, to a consumer or cardholder 122, who uses the transaction card to tender payment for a purchase from a merchant 124. To accept payment with the transaction card, merchant 124 must normally establish an account with a financial institution that is part of the financial payment system. This financial institution is usually called the “merchant bank,” the “acquiring bank,” or the “acquirer.” When cardholder 122 tenders payment for a purchase with a transaction card, merchant 124 requests authorization from a merchant bank 126 for the amount of the purchase. The request may be performed over the telephone, but is usually performed through the use of a point-of-sale terminal, which reads cardholder's 122 account information from a magnetic stripe, a chip, or embossed characters on the transaction card and communicates electronically with the transaction processing computers of merchant bank 126. Alternatively, merchant bank 126 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 128, computers of merchant bank 126 or merchant processor will communicate with computers of an issuer bank 130 to determine whether cardholder's 122 account 132 is in good standing and whether the purchase is covered by cardholder's 122 available credit line. Based on these determinations, the request for authorization will be declined or accepted. If the request is accepted, an authorization code is issued to merchant 124.

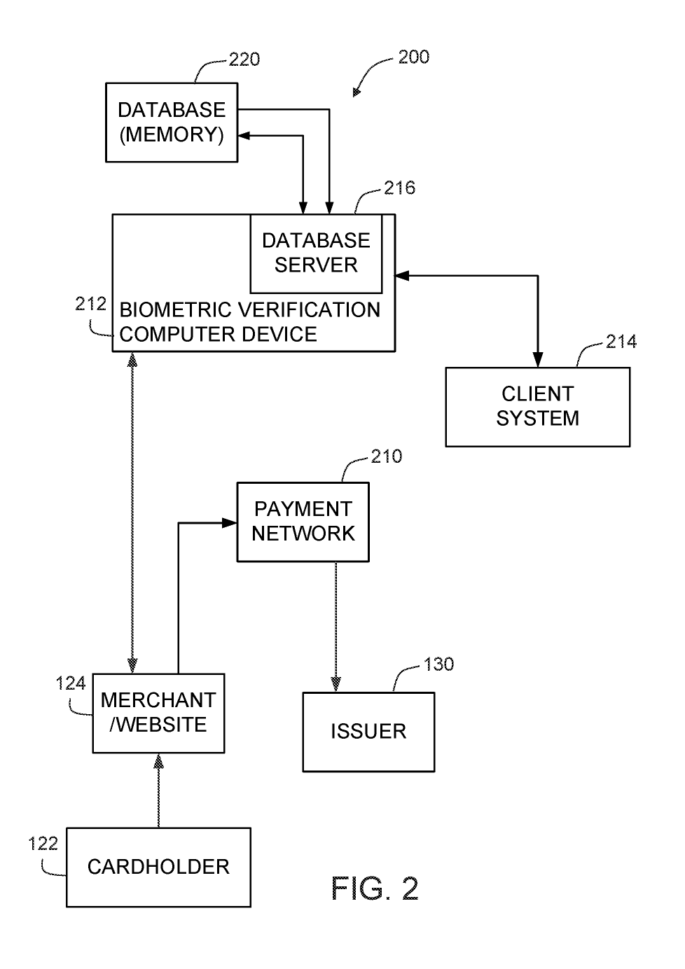

When a request for authorization is accepted, the available credit line of cardholder's 122 account 132 is decreased. Normally, a charge for a payment card transaction is not posted immediately to cardholder's 122 account 132 because bankcard associations, such as MasterCard International Incorporated®, have promulgated rules that do not allow merchant 124 to charge, or “capture,” a transaction until goods are shipped or services are delivered. However, with respect to at least some debit card transactions, a charge may be posted at the time of the transaction. When merchant 124 ships or delivers the goods or services, merchant 124 captures the transaction by, for example, appropriate data entry procedures on the point-of-sale terminal. This may include bundling of approved transactions daily for standard retail purchases. If cardholder 122 cancels a transaction before it is captured, a “void” is generated. If cardholder 122 returns goods after the transaction has been captured, a “credit” is generated. Interchange network 128 and/or issuer bank 130 stores the transaction card information, such as a category of merchant, a merchant identifier, a location where the transaction was completed, amount of purchase, date and time of transaction, in a database 220 (shown in FIG. 2).

After a purchase has been made, a clearing process occurs to transfer additional transaction data related to the purchase among the parties to the transaction, such as merchant bank 126, interchange network 128, and issuer bank 130. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

For debit card transactions, when a request for a personal identification number (PIN) authorization is approved by the issuer, cardholder's account 132 is decreased. Normally, a charge is posted immediately to cardholder's account 132. The payment card association then transmits the approval to the acquiring processor for distribution of goods/services or information, or cash in the case of an automated teller machine (ATM).

After a transaction is authorized and cleared, the transaction is settled among merchant 124, merchant bank 126, and issuer bank 130. Settlement refers to the transfer of financial data or funds among merchant's 124 account, merchant bank 126, and issuer bank 130 related to the transaction. Usually, transactions are captured and accumulated into a “batch,” which is settled as a group. More specifically, a transaction is typically settled between issuer bank 130 and interchange network 128, and then between interchange network 128 and merchant bank 126, and then between merchant bank 126 and merchant 124.

FIG. 2 is a simplified block diagram of an example system 200 used for authenticating a user using biometric data. In the example embodiment, system 200 may be used for performing payment-by-card transactions received as part of processing cardholder transactions. In addition, system 200 is a payment processing system that includes a biometric verification computer device 212, also known as a biometric verification server 212, configured to enhance payment transaction authentication using cardholder biometric data. As described below in more detail, biometric verification computer device 212 is configured to store a plurality of biometric identifiers and receive an authentication request message for a payment transaction originating from an originating merchant 124 for a cardholder 122 (both shown in FIG. 1). The authentication request message includes biometric information provided by cardholder 122. Biometric verification computer device 212 is configured to search the plurality of biometric identifiers for a match to the received biometric identifier and determine whether to approve or deny the payment card transaction based, at least in part on, on whether or not a match is found. Biometric verification computer device 212 is also configured to transmit the determination to the requestor.

In the example embodiment, client systems 214 are specially programmed computers that include a web browser or a software application to enable client systems 214 to access biometric verification computer device 212 using the Internet. More specifically, client systems 214 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client systems 214 can be any device capable of accessing the Internet including, but not limited to, a desktop computer, a laptop computer, a personal digital assistant (PDA), a cellular phone, a smartphone, a tablet, a phablet, a smart watch, or other web-based connectable equipment. In the example embodiment, cardholder 122 uses a client system 214 to access a commerce website for merchant 124. In the example embodiment, client systems 214 include a sensor (not shown) that allows client system 214 to receive biometric information from a user. For example the sensor may include, but is not limited to, a camera, a fingerprint scanner, and a microphone.

A database server 216 is communicatively coupled to a database 220 that stores data. In one embodiment, database 220 includes biometric data, transaction histories, and blacklisted cardholders. In the example embodiment, database 220 is stored remotely from biometric verification computer device 212. In some embodiments, database 220 is decentralized. In the example embodiment, a person can access database 220 via client systems 214 by logging onto biometric verification computer device 212, as described herein.

Biometric verification computer device 212 is communicatively coupled with payment network 210. Payment network 210 represents one or more parts of payment network 120 (shown in FIG. 1). In the example embodiment, biometric verification computer device 212 is in communication with one or more computer devices associated with interchange network 128. In other embodiments, biometric verification computer device 212 is in communication with one or more computer devices associated with merchant bank 126 (shown in FIG. 1). In some embodiments, biometric verification computer device 212 may be associated with, or is part of payment network 120, or in communication with payment network 120, shown in FIG. 1. In other embodiments, biometric verification computer device 212 is associated with a third party and is in communication with payment network 120. In some embodiments, biometric verification computer device 212 may be associated with, or be part of merchant bank 126, interchange network 128, and issuer bank 130. In addition, biometric verification computer device 212 is communicatively coupled with merchant 124. In the example embodiment, biometric verification computer device 212 is in communication with merchant 124 and client systems 214 via Application Programming Interface (API) calls. Through the API call, merchant 124 may transmit information to and receive information from biometric verification computer device 212.

In some embodiments, biometric verification computer device 212 may be associated with the financial transaction interchange network 128 shown in FIG. 1 and may be referred to as an interchange computer system. Biometric verification computer device 212 may be used for processing transaction data and analyzing for fraudulent transactions. In addition, at least one of client systems 214 may include a computer system associated with an issuer 130 of a transaction card. Accordingly, biometric verification computer device 212 and client systems 214 may be utilized to process transaction data relating to purchases a cardholder 122 makes utilizing a transaction card processed by interchange network 128 and issued by the associated issuer 130. At least one client system 214 may be associated with a user or a cardholder 122 seeking to register, access information, or process a transaction with at least one of interchange network 128, issuer 130, or merchant 124. In addition, client systems 214 may include point-of-sale (POS) devices associated with merchant 124 and used for processing payment transactions.

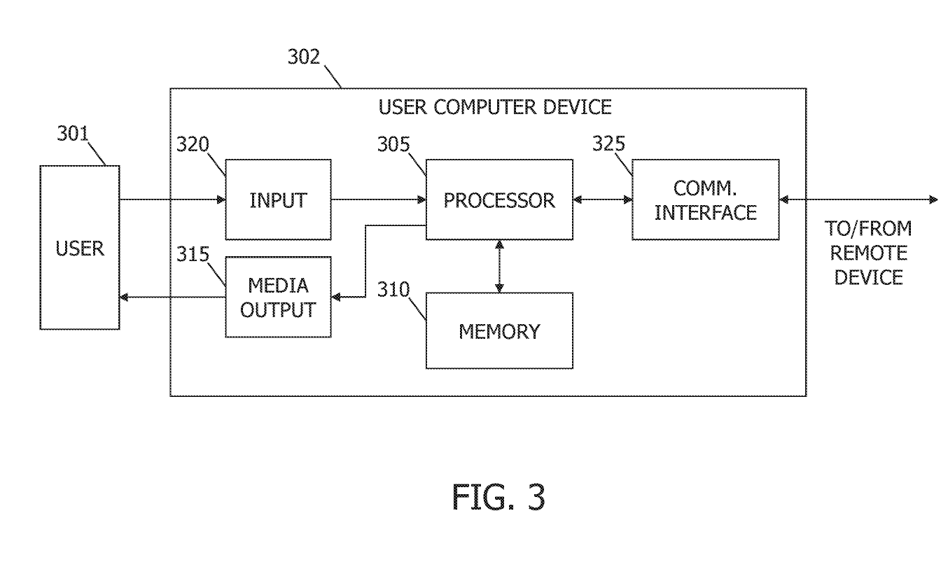

FIG. 3 illustrates an example configuration of a client system 214 shown in FIG. 2, in accordance with one embodiment of the present disclosure. User computer device 302 is operated by a user 301. User computer device 302 may include, but is not limited to, client systems 214, computer devices associated with merchant 124, and computer devices associated with cardholder 122 (both shown in FIG. 1). User computer device 302 includes a processor 305 for executing instructions. In some embodiments, executable instructions are stored in a memory area 310. Processor 305 may include one or more processing units (e.g., in a multi-core configuration). Memory area 310 is any device allowing information such as executable instructions and/or transaction data to be stored and retrieved. Memory area 310 may include one or more computer-readable media.

User computer device 302 also includes at least one media output component 315 for presenting information to user 301. Media output component 315 is any component capable of conveying information to user 301. In some embodiments, media output component 315 includes an output adapter (not shown) such as a video adapter and/or an audio adapter. An output adapter is operatively coupled to processor 305 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 315 is configured to present a graphical user interface (e.g., a web browser and/or a client application) to user 301. A graphical user interface may include, for example, an online store interface for viewing and/or purchasing items, and/or a wallet application for managing payment information. In some embodiments, user computer device 302 includes an input device 320 for receiving input from user 301. User 301 may use input device 320 to, without limitation, select and/or enter one or more items to purchase and/or a purchase request, or to access credential information, and/or payment information. Input device 320 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 315 and input device 320. In the example embodiment, input device 320 is configured to receive biometric information from user 301. Examples of biometric information include, but are not limited to, a, image of user 301, an image of a portion of user 301, such as a fingerprint of user 301, a retinal scan of user 301, an iris scan of user 301, hand geometry, earlobe geometry, voice print, keystroke dynamics, DNA, and/or signatures.

User computer device 302 may also include a communication interface 325, communicatively coupled to a remote device such as biometric verification computer device 212 (shown in FIG. 2). Communication interface 325 may include, for example, a wired or wireless network adapter and/or a wireless data transceiver for use with a mobile telecommunications network.

Stored in memory area 310 are, for example, computer-readable instructions for providing a user interface to user 301 via media output component 315 and, optionally, receiving and processing input from input device 320. The user interface may include, among other possibilities, a web browser and/or a client application. Web browsers enable users, such as user 301, to display and interact with media and other information typically embedded on a web page or a website from biometric verification computer device 212. A client application allows user 301 to interact with, for example, biometric verification computer device 212. For example, instructions may be stored by a cloud service and the output of the execution of the instructions sent to the media output component 315.

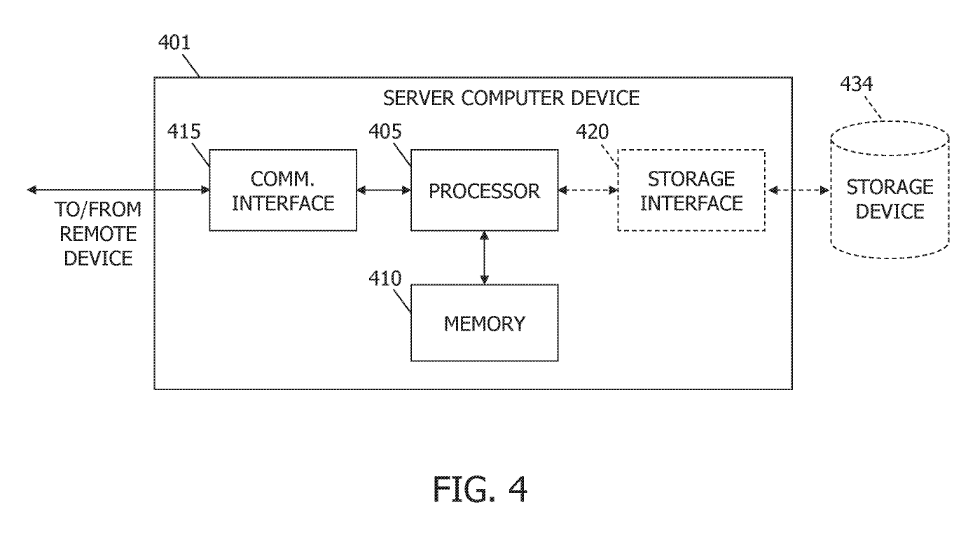

FIG. 4 illustrates an example configuration of a server system shown in FIG. 2, in accordance with one embodiment of the present disclosure. Server computer device 401 may include, but is not limited to, database server 216, merchant/website server 124, and biometric verification computer device 212 (all shown in FIG. 2). Server computer device 401 also includes a processor 405 for executing instructions. Instructions may be stored in a memory area 410. Processor 405 may include one or more processing units (e.g., in a multi-core configuration).

Processor 405 is operatively coupled to a communication interface 415 such that server computer device 401 is capable of communicating with a remote device such as another server computer device 401, client systems 214, merchant/website server 124, or biometric verification computer device 212 (all shown in FIG. 2). For example, communication interface 415 may receive requests from client systems 214 via the Internet.

Processor 405 may also be operatively coupled to a storage device 434. Storage device 434 is any computer-operated hardware suitable for storing and/or retrieving data, such as, but not limited to, data associated with database 220 (shown in FIG. 2). In some embodiments, storage device 434 is integrated in server computer device 401. For example, server computer device 401 may include one or more hard disk drives as storage device 434. In other embodiments, storage device 434 is external to server computer device 401 and may be accessed by a plurality of server computer devices 401. For example, storage device 434 may include a storage area network (SAN), a network attached storage (NAS) system, and/or multiple storage units such as hard disks and/or solid state disks in a redundant array of inexpensive disks (RAID) configuration.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

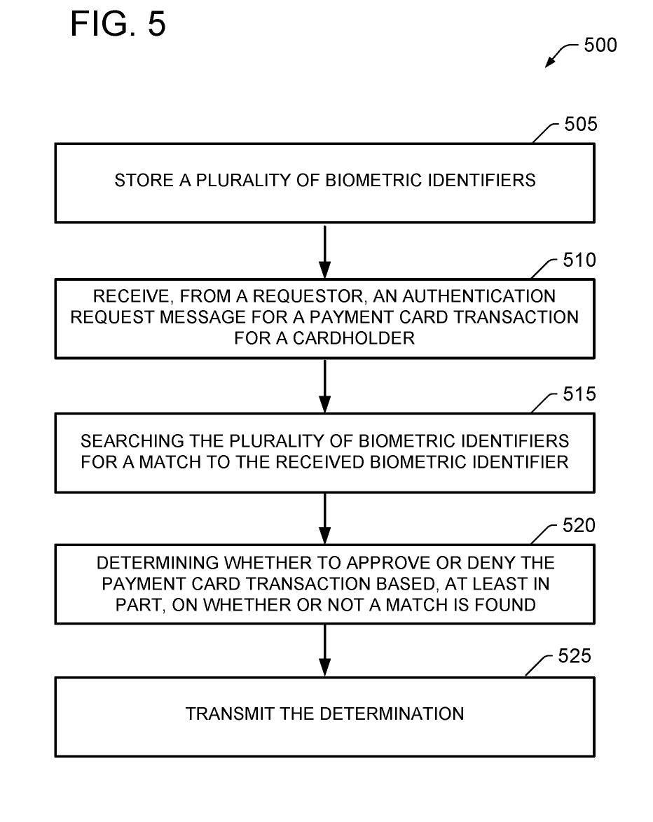

Processor 405 executes computer-executable instructions for implementing aspects of the disclosure. In some embodiments, processor 405 is transformed into a special purpose microprocessor by executing computer-executable instructions or by otherwise being programmed. For example, processor 405 is programmed with the instructions such as are illustrated in FIG. 5.

FIG. 5 is a flow chart of a process 500 for authenticating a user using biometric data using system 200 shown in FIG. 2. In the example embodiment, process 500 is performed by biometric verification computer device 212 (shown in FIG. 2).

In the example embodiment, biometric verification computer device 212 stores 505 a plurality of biometric identifiers in database 220 (shown in FIG. 2). The biometric identifiers are associated with payment card accounts. In the example embodiment, the payment card accounts are associated with one or more issuer banks 130 (shown in FIG. 1). In some embodiments, each of the plurality of biometric identifiers are associated with cardholders 122 (shown in FIG. 1) who have been put on a blacklist, where the cardholder committed fraudulent behavior on the associated payment card account. In other embodiments, the plurality of biometric identifiers is stored with payment transaction history information, such as a plurality of historical payment transactions, associated with the payment account and the associated biometric identifier. In still other embodiments, each of the plurality of biometric identifiers are associated with cardholder 122 who are on a whitelist or are approved for enhanced authentication or approval. In the example embodiment, at least one of merchant bank 126, interchange network 128 (both shown in FIG. 1), and issuer bank 130 added the biometric identifier and the associated transaction history to database 220. In the example embodiment, cardholder 122, associated with each biometric identifier of the plurality of biometric identifiers, provided the biometric identifier as a part of a biometric authentication service for the associated payment card.

In the example embodiment, cardholder 122 is enrolled in a biometric authentication service that uses the cardholder's biometric information to confirm the identity of cardholder 122. In the example embodiment, as a step of initiating a payment transaction, cardholder 122 provides one or more biometric identifiers, such as, but not limited to, a fingerprint, an image, a retinal scan, and a voice print through a client system 214 (shown in FIG. 2). At least one of merchant 124, merchant bank 126, interchange network 128, and issuer 130 compares the provided biometric identifier to a stored sample biometric identifier that was provided previously by cardholder 122, such as when cardholder 122 signed up for the biometric authentication service. If the stored sample and the provided biometric identifier match, then the identity of cardholder 122 is confirmed as the cardholder 122 associated with the payment card being used in the payment transaction.

In the example embodiment, biometric verification computer device 212 receives 510 an authentication request message from a requestor. The authentication request message is for a payment transaction originating from an origination merchant 124 (shown in FIG. 1) for a cardholder 122 (shown in FIG. 1). The authentication request message includes the biometric identifier used to confirm the identity of cardholder 122. Biometric verification computer device 212 searches 515 the plurality of biometric identifiers for a match to the received biometric identifier. In the example embodiment, biometric verification computer device 212 compares the received biometric identifier to the stored plurality of biometric identifiers to find a match. The technique for comparison used varies based on the type of biometric identifier. In the example embodiment, the plurality of biometric identifiers is indexed based on the identifier and not by other identifying information.

In some embodiments, biometric verification computer device 212 determines 520 whether to approve or deny the payment transaction based, at least in part, on whether or not a match is found. In some embodiments, each of the plurality of biometric identifiers is associated with a cardholder that has performed fraudulent transactions on a payment card and have been blacklisted by at least one of a merchant bank 126, an interchange network 128, or an issuer bank 130. Since this blacklisting may occur on different interchange networks 128 or issuer banks 130, the interchange network 128 and issuer bank 130 associated with the present payment transaction may not have access to the blacklist and not be aware that an individual is blacklisted elsewhere. This may be the case where cardholder 122 has multiple cards associated with multiple interchange networks 128 and issuer processors 130. Cardholder 122 may perform fraudulent transactions on one payment card, causing cardholder 122 to become blacklisted by at least one of the interchange network 128 and the issuer bank 130 associated with that payment card. However, cardholder 122 can then use his or her other payment cards without being affected by the blacklist. By comparing the biometric identifier from cardholder 122 to the plurality of biometric identifiers from blacklisted cardholders, biometric verification computer device 212 may determine if cardholder 122 has been blacklisted. If there is a match, biometric verification computer device 212 determines 520 to deny the payment transaction. If there is not a match, biometric verification computer device 212 determines 520 to approve the payment transaction. Biometric verification computer device 212 transmits 525 the determination to the requestor in an authentication response message.

In some other embodiments, biometric verification computer device 212 transmits whether or not a match to the biometric identifier was found to the requestor. The requestor is then configured to determine whether to approve or deny the payment transaction based, at least in part on whether or not a match was found.

In some embodiments, where the plurality of biometric identifiers are associated with transaction histories, biometric verification computer device 212 calculates a fraud score based on the transaction history associated with the match. In some further embodiments, the authentication request message includes one or more pieces of authentication data that biometric verification computer device 212 uses to calculate the fraud score. If the fraud score exceeds a predetermined threshold, biometric verification computer device 212 determines 520 to deny the payment transaction. Otherwise, biometric verification computer device 212 determines 520 to approve the payment transaction.

In some embodiments, an applicant may initiate an online credit request application with an issuer bank 130. The credit request application may be for a payment card, a loan, a line of credit, or any other credit request. In these embodiments, the applicant uses a client system 214, such as a smart phone, to initiate the online credit request application. As a part of the online credit request application, the applicant may sign the credit request application with a biometric signature, such as through a biometric authentication service. For example, the applicant may transmit one or more biometric identifiers as a part of the application process. In these embodiments, a computer system associated with issuer bank 130 transmits a query to biometric verification computer device 212 with the one or more biometric identifiers to verify the identity of potential cardholder. Based on the information returned by biometric verification computer system 212, issuer bank 130 determines whether or not to approve the credit request application. In some further embodiments, the applicant may be at a branch of issuer bank 130. Issuer bank 130 may collect the potential cardholder's biometric information in person to transmit to biometric verification computer device 212 for authentication.

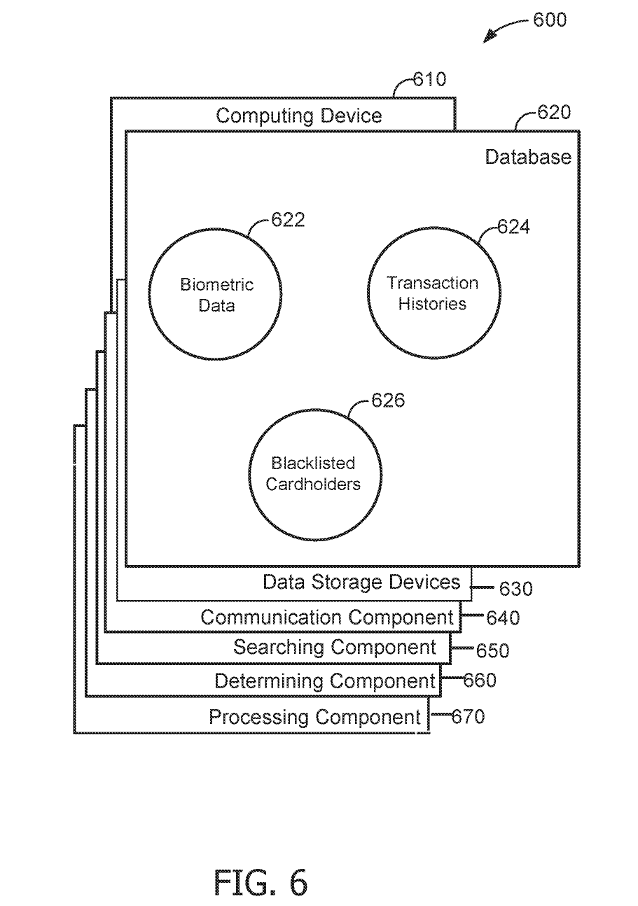

FIG. 6 is a diagram 600 of components of one or more example computing devices that may be used in system 200 shown in FIG. 2. In some embodiments, computing device 610 is similar to biometric verification computer device 212 (shown in FIG. 2). Database 620 may be coupled with several separate components within computing device 610, which perform specific tasks. In this embodiment, database 620 includes biometric data 622, transaction histories 624, and blacklisted cardholders 626. In some embodiments, database 620 is similar to database 220 (shown in FIG. 2).

Computing device 610 includes database 620, as well as data storage devices 630. Computing device 610 also includes a communication component 640 for receiving 510 an authorization request message and transmitting 525 the determination (both shown in FIG. 5). Computing device 610 also includes a searching component 650 for searching 515 the plurality of biometric identifies (shown in FIG. 5). Computing device 610 further includes a determining component 660 for determining 520 whether to approve or deny (shown in FIG. 5). A processing component 670 assists with execution of computer-executable instructions associated with the system.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial locational differences from the literal languages of the claims.

What is claimed is:

1. A computer-based method for authenticating a user using biometric data, said method implemented using a biometric validation server in communication with a memory, said method comprising:
storing, at the biometric validation server, a plurality of biometric identifiers;
receiving, from a requestor, an authentication request message for a payment transaction originating from an originating merchant for a cardholder, wherein the authentication request message includes a biometric identifier provided by the cardholder;
searching, at the biometric validation server, the plurality of biometric identifiers for a match to the received biometric identifier;
determining whether to approve or deny the payment card transaction based, at least in part on, on whether or not a match is found; and
transmitting the determination.

2. A method in accordance with claim 1 further comprising storing a plurality of transaction histories associated with the plurality of biometric identifiers, wherein the plurality of transaction histories are associated with a cardholder and a corresponding payment card.

3. A method in accordance with claim 2, wherein the authentication request message further includes authentication information, and wherein determining whether to approve or deny further comprises:
if a match is found, retrieving the stored transaction history associated with the matching biometric identifier;
calculating a fraud score based on the stored transaction history and the authentication information; and
determining whether to approve or deny the transaction based on the fraud score.

4. A method in accordance with claim 1, wherein the plurality of biometric identifiers is searchable based on the biometric identifier.

5. A method in accordance with claim 1, wherein the biometric identifier is one of a fingerprint, a photograph, and a retinal scan.

6. A method in accordance with claim 1, wherein the requestor is one of a merchant, an acquiring bank, and a payment network.

7. A method in accordance with claim 1, wherein the plurality of biometric identifiers are each associated with a blacklisted cardholder.

8. A method in accordance with claim 7 further comprising determining to deny the payment card transaction if a match is found.

9. A method in accordance with claim 1, further comprising transmitting whether or not a match is found to the requestor, wherein the requestor is configured to determine whether to approve or deny the payment card transaction based, at least in part on, on whether or not a match is found.

10. A method in accordance with claim 1 further comprising:
receiving a biometric identifier for the cardholder based on the transaction history of the cardholder, wherein the transaction history is associated with a first payment card associated with the cardholder;
storing the biometric identifier; and
receiving the authentication request message including a biometric identifier for the cardholder, wherein the authentication request message is associated with a payment transaction associated with a second payment card associated with the cardholder.

11. A method in accordance with claim 10, wherein the first payment card is associated with a first issuer and the second payment card is associated with a second issuer.

12. A method in accordance with claim 1, wherein the cardholder is associated with a plurality of payment cards including a first payment card and a second payment card.

13. A biometric verification computer device used for authenticating a user using biometric data, said biometric verification device comprising a processor communicatively coupled to a memory device, said processor programmed to:
store a plurality of biometric identifiers;
receive, from a requestor, an authentication request message for a payment transaction originating from an originating merchant for a cardholder, wherein the authentication request message includes a biometric identifier provided by the cardholder;
search the plurality of biometric identifiers for a match to the received biometric identifier; and
transmit a response to the requestor.

14. A biometric verification computer device in accordance with claim 13, wherein said processor is further programmed to:
determine whether to approve or deny the payment card transaction based, at least in part on, on whether or not a match is found; and
transmit the determination to the requestor.

15. A biometric verification computer device in accordance with claim 14, wherein the authentication request message further includes authentication information, and wherein said processor is further programmed to:
store a plurality of transaction histories associated with the plurality of biometric identifiers, wherein the plurality of transaction histories are associated with a cardholder and a corresponding payment card;
if a match is found, retrieve the stored transaction history associated with the matching biometric identifier;
calculate a fraud score based on the stored transaction history and the authentication information; and
determine whether to approve or deny the transaction based on the fraud score.

16. A biometric verification computer device in accordance with claim 13, wherein the biometric identifier is one of a fingerprint, a photograph, and a retinal scan.

17. A biometric verification computer device in accordance with claim 13, wherein the plurality of biometric identifiers are each associated with a blacklisted cardholder.

18. A biometric verification computer device in accordance with claim 13 wherein said processor is further programmed to:
receive a biometric identifier for the cardholder based on the transaction history of the cardholder, wherein the transaction history is associated with a first payment card associated with the cardholder;
store the biometric identifier; and
receive the authentication request message including a biometric identifier for the cardholder, wherein the authentication request message is associated with a payment transaction associated with a second payment card associated with the cardholder.

19. A biometric verification computer device in accordance with claim 13, wherein said processor is further programmed to determine a fraud score for the payment card transaction based on the comparison.

20. At least one non-transitory computer-readable storage media having computer-executable instructions embodied thereon, wherein when executed by a biometric verification computer device having at least one processor coupled to at least one memory device, the computer-executable instructions cause the processor to:
store a plurality of biometric identifiers;
receive, from a requestor, an authentication request message for a payment transaction originating from an originating merchant for a cardholder, wherein the authentication request message includes a biometric identifier provided by the cardholder;
search the plurality of biometric identifiers for a match to the received biometric identifier; and
transmit a response to the requestor.
